(19) United States
(12) Patent Application Publication
(10) Pub. No.: US 2013/0124438 A1
(43) Pub. Date: May 16, 2013

(54) METHOD OF RECOGNIZING PATTERNS BASED ON MARKOV CHAIN HIDDEN CONDITIONAL RANDOM FIELD MODEL

(71) Applicants: Sung-Young LEE, Gyeonggi-do (KR); Young-Koo Lee, Suwon-si (KR); La The Vinh, Yongin-si (KR)

(72) Inventors: Sung-Young LEE, Gyeonggi-do (KR); Young-Koo Lee, Suwon-si (KR); La The Vinh, Yongin-si (KR)

(21) Appl. No.: 13/307,219

(22) Filed: Nov. 30, 2011

(30) Foreign Application Priority Data
Nov. 11, 2011 (KR) 10-2011-0117870

(51) Int. Cl. G06F 15/18

(52) U.S. Cl. 706/12

(57) ABSTRACT

Provided is a method of recognizing patterns based on a hidden conditional random fields model to which full-Gaussian covariance has been applied. The method includes dividing a training input signal and outputting a frame sequence, extracting a feature vector from the frame sequence, calculating a parameter through a conditional random fields model to which Gaussian covariance has been applied using the feature vector, receiving, by the hidden conditional random fields model to which the parameter has been applied, a feature vector extracted from a test input signal measured for an actual pattern to infer a label indicating the actual pattern, and proposing a method of calculating gradient values for a conditional probability vector, a transition probability vector, a Gaussian mixture weight, a mean of Gaussian distributions, and covariance of the Gaussian distributions, as an analysis method.

### CROSS-REFERENCE TO RELATED APPLICATION

This application claims the benefit under 35 U.S.C. §119 (a) of Korean Patent Application No. 10-2011-0117870, filed on Nov. 11, 2011, the disclosure of which is incorporated herein in its entirety by reference.

### BACKGROUND

1. Field

The following description relates to a method of recognizing patterns based on a hidden conditional random fields model.

2. Description of the Related Art

As a variety of pattern recognition methods are applied from the industrial field to ordinary life, the importance and use of the pattern recognition methods are gradually increasing.

In relation to an algorithm for recognizing sequential patterns, a conditional random fields model is often used. [John Laffery et al., 2001].

However, a conventional conditional random fields model cannot model sequential patterns with long-term relationships. A variety of research into resolving this problem has been conducted. A variety of changes of the conditional random field [Sunita Sarawagi et al., 2004, and D. L. Vail et al., 2001] have been issued but have excessive complexity or have not completely resolved the specified problem. For example, an initial conditional random field proposed by John Laffery et al. in 2001 cannot model the duration of states due to the Markov assumption.

The Markov-chain hidden conditional random fields model has been proved to be an excellent method for classification of, particularly, sequential data such as speech and videos. A hidden Markov model has been widely used in many pattern recognition-related applications such as speech recognition, video classification, and gene classification for over ten years.

However, limitations on the hidden Markov model have been recently revealed from the generative nature [A. Gunawardana et al., 2005; S. B. Wang et al., 2006]. A maximum entropy Markov model (MEMM) overcomes the limitations of the hidden Markov model, and exhibits excellent results, particularly, in the fields of distinguishing parts of language [A. Ratnaparkhi, 1996], automatic speech recognition (ASR) [H. K. J. Kuo et al., 2006], information extraction [A. McCallum, 2000], etc. However, the MEMM is known to be susceptible to a label bias problem.

The Markov chain hidden conditional random fields model has all advantages of the MEMM and has resolved the label bias problem. The Markov chain hidden conditional random fields model can create a wider parameter space (allowing weighted parameters) than the Markov hidden model or the MEMM. However, the Markov-chain hidden conditional random fields model has no tool capable of utilizing a full-covariance combination of Gaussian density functions.

### SUMMARY

The following description relates to a new hidden conditional random fields model that utilizes a full-covariance Gaussian density function, and an algorithm for recognizing patterns using the new hidden conditional random fields model, since there is no tool for a hidden conditional random fields model that can use the full-covariance Gaussian density function.

According to an exemplary aspect, there is provided a method including: dividing an input signal measured from a variety of inputs and outputting a frame sequence; extracting a feature vector from the frame sequence; combining full-covariance Gaussian distributions with a hidden conditional random fields model; receiving, by the hidden conditional random fields model, combinations of the feature vector and a label indicating a specific activity to obtain a parameter of the hidden conditional random fields model; receiving, by the hidden conditional random fields model to which the parameter has been applied, a feature vector extracted from a test input signal measured for an actual activity to infer a label indicating the actual activity and indicate a sequence of a specific state; applying a gradient function-applied algorithm for analyzing the sequence of the specific state; and calculating probability of a state sequence.

Additional aspects of the invention will be set forth in the description which follows, and in part will be apparent from the description, or may be learned by practice of the invention.

According to the present invention, training and inferring are simultaneously performed in the hidden conditional random fields model combined with full-covariance Gaussian distributions in recognizing patterns such as a variety of actual activities, thereby effectively recognizing changes of long-term activities. A new analysis method of analyzing the hidden conditional random fields model is proposed to enable the changes to be recognized in real time.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the aspects of the invention.

FIG. 1 is a block diagram illustrating a training step in a classification system using a full-covariance Gaussian-mixed hidden conditional random fields model; and

FIG. 2 is a block diagram illustrating a classification step in a classification system using a full-covariance Gaussian-mixed hidden conditional random fields model.

### DETAILED DESCRIPTION

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

The present invention relates to pattern recognition such as emotion recognition and activity recognition. Here, emotion recognition refers to identifying emotion states such as angry, happy, sad or neutral and activity recognition refers to identifying movement states such as walking, running, lying down or turning. In addition, the present invention may be applied to a variety of pattern recognitions, such as speech recognition, face recognition, and fingerprint and iris recognition. Hereinafter, emotion recognition will be described as an example of the pattern recognition.

In the field of pattern recognition, a Markov chain hidden conditional random fields model is not explicitly used for covariance Gaussian distributions, which degrades accuracy of a recognition system.

The present invention provides a hidden conditional random fields model that applies covariance Gaussian distributions in the Markov chain hidden conditional random fields model to increase accuracy of a recognition system and that applies a new analysis method.

As a result, the present invention provides a hidden conditional random fields model having an algorithm that simultaneously performs faster and more exact training and inferring than a conventional hidden Markov model by extending a hidden conditional random fields model.

As a new hidden conditional random fields model including a combination of full-covariance Gaussian distributions, which overcomes limitations of an existing hidden conditional random fields model, Equations 1, 2 and 3 are determined.

$$p ( Y \vert X ; Λ ) = \frac{{\sum }_{\overline{S}}^{ } exp \{ Λ \cdot f ( Y , \overline{S} , X ) \}}{z ( X , Λ )} \\ z ( X , Λ ) = {\sum }_{{Y}^{′}}^{ } P ( {Y}^{′} \vert X ; Λ ) \qquad [ Equations 1 ]$$

In Equations 1, z(X, Λ) denotes a normalization factor, X denotes input training data, Y denotes a training label of the input value X, f denotes a feature vector of the model, S̅ denotes a hidden-state sequence. Λ denotes a parameter vector of a set model including a weight indicating prior/transition/observation features.

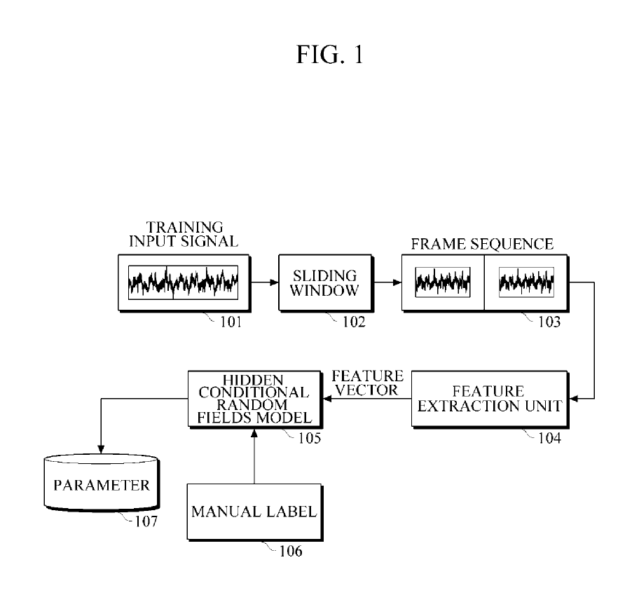

Conditional probability of a data label 207 calculated from the input data and a hidden conditional random fields model 205 to which a parameter 206 calculated in FIG. 1 has been applied is calculated by a label state sequence probability p(Y|X; Λ) p(Y|j X; Λ) is defined by Equations 1.

$${f}_{s}^{Prior} ( Y , \overline{S} , X ) = δ ( {s}_{1} = s ) ∀ s \\ {f}_{{ss}^{′}}^{Transition} ( Y , \overline{S} , X ) = {\sum }_{t = 1}^{T} δ ( {s}_{t - 1} = s ) δ ( {s}_{t} = {s}^{′} ) ∀ s , {s}^{′} \\ {f}_{s}^{Occurence} ( Y , \overline{S} , X ) = {\sum }_{t = 1}^{T} δ ( {s}_{t} = s ) ∀ s \\ {f}_{s}^{M 1} ( Y , \overline{S} , X ) = {\sum }_{t = 1}^{T} δ ( {s}_{t} = s ) {x}_{t} ∀ s \\ {f}_{s}^{M 2} ( Y , \overline{S} , X ) = {\sum }_{t = 1}^{T} δ ( {s}_{t} = s ) {x}_{t}^{2} ∀ s \qquad [ Equations 2 ]$$

Equations 2 form a Markov chain model together with a single Gaussian distribution and is selected as above. δ denotes a delta function Xₜ denotes a data vector for a time t, and xₜ² denotes a square per component of Xₜ.

Since xₜ² is the square per component of xₜ as described above, components of xₜ² cannot learn intersection relationship information from each other. That is, the Gaussian distributions have a diagonal covariance matrix on the assumption that the components are independently pair-wise. However, this has a limitation in that there is a difference in reality.

$$p ( Y \vert X ; Λ ) = \frac{{\sum }_{\overline{S}}^{ } {\sum }_{m = 1}^{M} exp \{ Λ f ( Y , \overline{S} , m , X ) ) \}}{z ( X , Λ )} \qquad [ Equation 3 ]$$

Equation 3 represents a conditional probability extended using a combination of the Gaussian density functions in Equations 1

In order to overcome limitations of Equations 2, a new hidden conditional random fields model that can utilize a combination of full-covariance Gaussian distributions rather than a diagonal covariance matrix is defined as follows.

$$\begin{matrix}{f}_{s}^{Prior} ( Y , \overline{S} , X ) = δ ( {s}_{1} = s ) ∀ s & [ Equation 4 ] \\ {f}_{{ss}^{′}}^{Transition} ( Y , \overline{S} , X ) = {\sum }_{t = 1}^{T} δ ( {s}_{t - 1} = s ) δ ( {s}_{t} = {s}^{′} ) ∀ s , {s}^{′} & [ Equation 5 ] \\ {f}_{s}^{Observation} ( Y , \overline{S} , X ) = {\sum }_{t = 1}^{T} log ( {\sum }_{m = 1}^{M} {Γ}_{s , m}^{Obs} N ( {x}_{t} , {μ}_{s , m} , {\sum }_{s , m} ) ) δ ( {s}_{t} = s ) & [ Equation 6 ]\end{matrix}$$

δ denotes a delta function, m denotes the number of density functions, D denotes a dimension of training data, F denotes a Gaussian mixture weight having a scalar value, μ denotes a mean vector of Gaussian distributions, Σ denotes a covariance matrix of the Gaussian distributions. Equations 4, 5 and 6 are feature functions calculated from the specific vector and represent a prior probability vector, a transition probability vector, and an observation probability vector, respectively. In Equation 6, a normal distribution N may be obtained through Equation 7.

$$\begin{matrix}N ( x , {μ}_{s , m} , {\sum }_{s , m} ) = \frac{1}{{( 2 π )}^{\frac{D}{2}} {\vert {\sum }_{s , m} \vert}^{\frac{1}{2}}} exp ( - \frac{1}{2} {( x - {μ}_{s , m} )}^{′} {\sum }_{s , m}^{- 1} ( x - {μ}_{s , m} ) ) {Λ}_{s}^{Obs} = 1 ∀ s & [ Equation 7 ] \\ \begin{matrix}\frac{d Score ( Y \vert X ; Λ , Γ , μ , Σ )}{d {Λ}_{s}^{Prior}} = {\sum }_{\overline{S}}^{ } \frac{d g ( Y , \overline{S} , X )}{d {Λ}_{s}^{Prior}} \\ exp ( g ( Y , \overline{S} , X ) ) \\ = {\sum }_{\overline{S}}^{ } {f}_{s}^{Prior} ( Y , \overline{S} , X ) \\ exp ( g ( Y , \overline{S} , X ) ) \\ = {β}_{1} ( s )\end{matrix} & [ Equation 8 ]\end{matrix}$$

The dScore function is a gradient function for a variable of the prior probability vector.

$$\begin{matrix}\frac{d Score ( Y \vert X ; Λ , Γ , μ , Σ )}{d {Λ}_{{ss}^{′}}^{Transition}} = {\sum }_{\overline{S}}^{ } \frac{d g ( Y , \overline{S} , X )}{d {Λ}_{{ss}^{′}}^{Transition}} \\ exp ( g ( Y , \overline{S} , X ) ) \\ = {\sum }_{\overline{S}}^{ } {f}_{{ss}^{′}}^{Transition} ( Y , \overline{S} , X ) \\ exp ( g ( Y , \overline{S} , X ) ) \\ = {\sum }_{t = 1}^{T} α ( t , s ) β ( t + 1 , {s}^{′} )\end{matrix} \qquad [ Equation 9 ]$$

The dScore function is a gradient function for a variable of the transition probability vector.

$$\frac{d Score ( Y \vert X ; Λ , Γ , μ , Σ )}{d {Γ}_{s , m}^{Obs}} = {\sum }_{\overline{S}} \frac{d g ( Y , \overline{S} , X )}{d {Γ}_{s , m}^{Obs}} exp ( g ( Y , \overline{S} , X ) ) = {\sum }_{\overline{S}} \frac{{f}_{s}^{Observation} ( Y , \overline{S} , X )}{d {Γ}_{s , m}^{Obs}} exp ( g ( Y , \overline{S} , X ) ) = {\sum }_{\overline{S}} {\sum }_{t = 1}^{T} \frac{N ( {x}_{t} , {μ}_{s , m} , {\sum }_{s , m} )}{{\sum }_{m = 1}^{M} {Γ}_{s , m}^{Obs} N ( {x}_{t} , {μ}_{s , m} , {\sum }_{s , m} )} δ ( {s}_{t} = s ) exp ( g ( Y , \overline{S} , X ) ) = {\sum }_{t = 1}^{T} \frac{N ( {x}_{t} , {μ}_{s , m} , {\sum }_{s , m} )}{{\sum }_{m = 1}^{M} {Γ}_{s , m}^{Obs} N ( {x}_{t} , {μ}_{s , m} , {\sum }_{s , m} )} α ( t , s ) γ ( t + 1 ) \qquad [ Equation 10 ]$$

The dScore function is a gradient function for a Gaussian mixture weight variable. Here, a function Y(t) is calculated as

$$γ ( t ) = {\sum }_{s} β ( t , s ) .$$

$$\frac{d Score ( Y \vert X ; Λ , Γ , μ , Σ )}{d {μ}_{s , m}} = {\sum }_{t = 1}^{T} \frac{{Γ}_{s , m}^{Obs} \frac{d N ( {x}_{t} , {μ}_{s , m} , {\sum }_{s , m} )}{d {μ}_{s , m}}}{{\sum }_{m = 1}^{M} {Γ}_{s , m}^{Obs} N ( {x}_{t} , {μ}_{s \cdot m} , {\sum }_{s \cdot m} )} α ( t , s ) γ ( t + 1 ) \qquad [ Equation 11 ]$$

The dScore function is a gradient function for the Gaussian distribution mean.

$$\frac{d Score ( Y \vert X ; Λ , Γ , μ , Σ )}{d {\sum }_{s \cdot m}} = {\sum }_{\vert t = 1}^{T} \frac{{Γ}_{s , m}^{Obs} \frac{d N ( {x}_{t} , {μ}_{s , m} , {\sum }_{s , m} )}{d {\sum }_{s , m}}}{{\sum }_{m = 1}^{M} {Γ}_{s , m}^{Obs} N ( {x}_{t} , {μ}_{s , m} , {\sum }_{s , m} )} α ( t , s ) γ ( t + 1 ) \qquad [ Equation 12 ]$$

The dScore function is a gradient function for covariance of the Gaussian distributions.

Equations 8, 9, 10, and 11 represent an analysis method algorithm for calculating values of gradients for a feature function, the mean of Gaussian distributions, and the covariance of the prior probability vector, the transition probability vector, and the observation probability vector obtained from Equations 4, 5, and 6.

In the present invention, the method is divided into a training step and an inference step in recognizing a variety of actual activities. The training step refers to a step of inputting data whose labels are known, of a recognition target and training the hidden conditional random fields model. For example, in the case of emotion recognition based on speech, speech representing joy, sorrow, pleasure, pain, and emotions whose states are known in advance are input as the training data. In the inference step, the inputs to be actually measured are classified based on parameters calculated in the training step.

FIG. 1 is a block diagram illustrating a training step in a classification system using a full-covariance Gaussian-mixed hidden conditional random fields model.

If an input signal 101 for training is input to a sliding window 102, the sliding window 102 divides the input signal into a frame sequence 103. The sliding window may divide the input signal using a hamming function. The hamming function is often used to design a filter and divides by a factor consisting of the number.

A feature extraction unit 104 receives the divided frame sequence 103 to extract a feature vector. Here, the feature vector refers to, for a speech signal as an example, distinct features such as amplitude, frequency, phase and a mean value of the speech. The extracted feature vector is input to a full-covariance Gaussian-mixed hidden conditional random fields model 105 of the present invention.

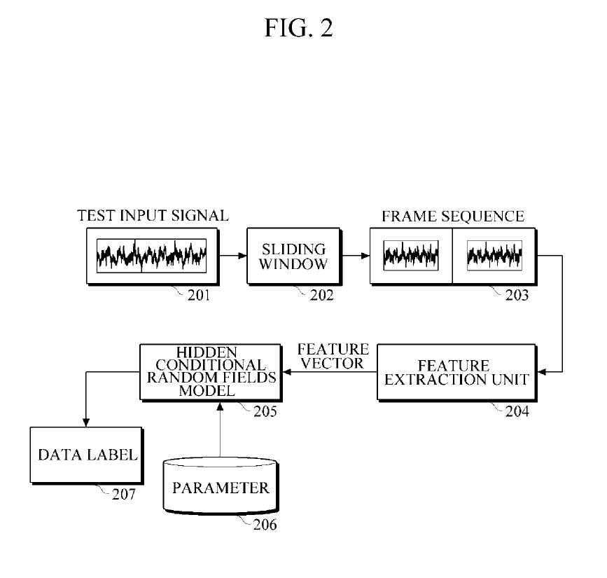

The hidden conditional random fields model 105 receives the feature vector together with a label 106, performs a training algorithm based on the gradient functions using Equations 4, 5 and 6 to create a parameter 107, and provides the parameter 107 to a parameter 206 of FIG. 2.

FIG. 2 is a block diagram illustrating a classification step in a classification system using a full-covariance Gaussian-mixed hidden conditional random fields model.

If an input signal 201 for testing is input to a sliding window 202 of FIG. 2, the sliding window creates one frame unit and provides the frame unit to a feature extraction unit 204. The feature extraction unit extracts feature vectors from signals of the frame unit.

The extracted feature vectors are input to the hidden conditional random fields model 205 to which the parameter 206 has been applied, which is created through the process of FIG. 1, and a data label 207 is created.

Consequently, according to the present invention, training and inferring using the feature vectors of the sequence can be simultaneously rapidly performed and the result of the pattern recognition can be output.

In the training step of the hidden conditional random fields model, a feature gradient is generally calculated by an LBFG method. However, in a current gradient calculation method, a forward and backward iterative execution algorithm is iteratively invoked, which requires a very great computational amount and accordingly degrades a computation speed. A new analysis method that decreases the invoking of the forward and backward iterative execution algorithms has been devised. Through the five gradient functions calculated using Equations 8, 9, 10, 11 and 12, real-time computation can be performed with a smaller computational amount and at a higher speed compared to an existing analysis method.

It will be apparent to those skilled in the art that various modifications and variations can be made in the present invention without departing from the spirit or scope of the invention. Thus, it is intended that the present invention covers the modifications and variations of this invention provided they come within the scope of the appended claims and their equivalents.

What is claimed is:

1. A method of recognizing sequential patterns based on a Markov chain hidden conditional random fields model, the method comprising:
(A) extracting a feature vector from a training input signal measured for a specific pattern;
(B) receiving, by a hidden conditional random fields model to which a combination of full-covariance Gaussian distributions has been applied, a plurality of combinations of the feature vector and a label indicating the specific pattern to obtain a parameter of the hidden conditional random fields model; and
(C) receiving, by the hidden conditional random fields model to which the parameter has been applied, a feature vector extracted from a test input signal measured for an actual pattern to infer a label indicating the actual pattern.

2. The method of claim 1, wherein step (A) comprises:
(A1) dividing the training input signal and outputting a frame sequence; and
(A2) extracting the feature vector of the training input signal from the frame sequence.

3. The method of claim 1, wherein the feature vector used in step (C) is extracted using the same algorithm as an algorithm applied to step (A).

4. The method of claim 1, wherein step (C) comprises receiving, by the hidden conditional random fields model to which the parameter has been applied, the feature vector of the test input signal to calculate probability of a state sequence indicating a sequence in a specific state.

5. The method of claim 1, wherein the combination of the full-covariance Gaussian distributions includes correlation information between different pairs of feature vectors.

6. The method of claim 1, wherein a feature function representing the feature vector includes three functions of a prior probability vector, a transition probability vector, and an observation probability vector,
the prior probability vector is calculated as ƒₛ^{Prior} (Y, S̅, X)-=δ(s₁=s)∀s,
the transition probability vector is calculated as
$${f}_{{ss}^{′}}^{Transition} ( Y , \overline{S} , X ) = {\sum }_{t = 1}^{T} δ ( {s}_{t - 1} = s ) δ ( {s}_{t} = {s}^{′} ) ∀ s , {s}^{′} ,$$
and
the observation probability vector is calculated as
$${f}_{s}^{Observation} ( Y , \overline{S} , X ) = {\sum }_{t = 1}^{T} log ( {\sum }_{m = 1}^{M} {Γ}_{s , m}^{Obs} N ( {x}_{t} , {μ}_{s , m} , {\sum }_{s , m} ) ) δ ( {s}_{t} = s ) ,$$
where a normal distribution N is calculated as
$$N ( x , {μ}_{s , m} , {\sum }_{s , m} ) = \frac{1}{{( 2 π )}^{\frac{D}{2}} {\vert {\sum }_{s , m} \vert}^{\frac{1}{2}}} exp ( - \frac{1}{2} {( x - {μ}_{s , m} )}^{′} {\sum }_{s , m}^{- 1} ( x - {μ}_{s , m} ) )$$
$${Λ}_{s}^{Obs} = 1 ∀ s ,$$
X denotes input training data, Y denotes a training label of an input value X, Λ denotes a parameter vector of a set model including a prior probability weight, a transition weight, and an observation weight, f denotes a feature vector of the model, S denotes a state sequence, S̅ denotes a hidden-state sequence, δ denotes a delta function, m denotes the number of density functions, D denotes a dimension of training data, r denotes a Gaussian mixture weight having a scalar value, μ denotes a mean vector of Gaussian distributions, Σ denotes a covariance matrix of the Gaussian distributions, and xₜ denotes a data vector for a time t.

7. The method of claim 6, wherein a gradient function for a prior probability variable of the prior probability vector is calculated as:
$$\frac{d Score ( Y \vert X ; Λ , Γ , μ , Σ )}{d {Λ}_{s}^{Prior}} = {\sum }_{\overline{S}} \frac{d g ( Y , \overline{S} , X )}{d {Λ}_{s}^{Prior}} exp ( g ( Y , \overline{S} , X ) ) = {\sum }_{\overline{S}} {f}_{s}^{Prior} ( Y , \overline{S} , X ) exp ( g ( Y , \overline{S} , X ) ) = {β}_{1} ( s ) ,$$
a gradient function for a transition probability variable of the transition probability vector is calculated as:
$$\frac{d Score ( Y \vert X ; Λ , Γ , μ , Σ )}{d {Λ}_{{ss}^{′}}^{Transition}} = {\sum }_{\overline{S}} \frac{d g ( Y , \overline{S} , X )}{d {Λ}_{{ss}^{′}}^{Transition}} exp ( g ( Y , \overline{S} , X ) ) = {\sum }_{\overline{S}} {f}_{{ss}^{′}}^{Transition} ( Y , \overline{S} , X ) exp ( g ( Y , \overline{S} , X ) ) = {\sum }_{t = 1}^{T} α ( t , s ) β ( t + 1 , {s}^{′} ) ,$$
a gradient function for a variable of the Gaussian mixture weight is calculated as:
$$\frac{d Score ( Y \vert X ; Λ , Γ , μ , Σ )}{d {Γ}_{s , m}^{Obs}} = {\sum }_{\overline{S}} \frac{d g ( Y , \overline{S} , X )}{d {Γ}_{s , m}^{Obs}} exp ( g ( Y , \overline{S} , X ) ) = {\sum }_{\overline{S}} \frac{{f}_{s}^{Observation} ( Y , \overline{S} , X )}{d {Γ}_{s , m}^{Obs}} exp ( g ( Y , \overline{S} , X ) ) = {\sum }_{\overline{S}} \dot{{{\sum }_{t = 1}}^{T}} \frac{N ( {x}_{t} , {μ}_{s , m} , {\sum }_{s , m} )}{{\sum }_{m = 1}^{M} {Γ}_{s , m}^{Obs} N ( {x}_{t} , {μ}_{s , m} , {\sum }_{s , m} )} δ ( {s}_{t} = s ) exp ( g ( Y , \overline{S} , X ) ) = {\sum }_{t = 1}^{T} \frac{N ( {x}_{t} , {μ}_{s , m} , {\sum }_{s , m} )}{{\sum }_{m = 1}^{M} {Γ}_{s , m}^{Obs} N ( {x}_{t} , {μ}_{s , m} , {\sum }_{s , m} )} α ( t , s ) γ ( t + 1 ) ,$$
a gradient function of a mean of the Gaussian distributions is calculated as:
$$\frac{d Score ( Y \vert X ; Λ , Γ , μ , Σ )}{d {μ}_{s , m}} = {\sum }_{t = 1}^{T} \frac{{Γ}_{s , m}^{Obs} \frac{d N ( {x}_{t} , {μ}_{s , m} {\sum }_{s , m} )}{d {μ}_{s , m}}}{{\sum }_{m = 1}^{M} {Γ}_{s , m}^{Obs} N ( {x}_{t} , {μ}_{s , m} , {\sum }_{s , m} )} α ( t , s ) γ ( t + 1 ) ,$$
and a gradient function for a covariance matrix of the Gaussian distributions is calculated as:
$$\frac{d Score ( Y \vert X ; Λ , Γ , μ , Σ )}{d {\sum }_{s , m}} = {\sum }_{\vert t = 1}^{T} \frac{{Γ}_{s , m}^{Obs} \frac{d N ( {x}_{t} , {μ}_{s , m} , {\sum }_{s , m} )}{d {\sum }_{s , m}}}{{\sum }_{m = 1}^{M} {Γ}_{s , m}^{Obs} N ( {x}_{t} , {μ}_{s , m} , {\sum }_{s , m} )} α ( t , s ) γ ( t + 1 ) ,$$
where a function γ(t) is calculated as:
$$γ ( t ) = {\sum }_{s} β ( t , s ) .$$

8. The method of claim 7, wherein p(Y|X; Λ) that is probability of the state sequence is calculated as:
$$p ( Y \vert X ; Λ ) = \frac{{\sum }_{\overline{S}} {\sum }_{m = 1}^{M} exp \{ Λ f ( Y , \overline{S} , m , X ) ) \text{\}}}{z ( x , Λ )} ,$$
and
a function z(X, Λ) is a normalization factor and is calculated as:
$$z ( X , Λ ) = {\sum }_{{Y}^{′}} P ( {Y}^{′} \vert X ; Λ ) ,$$
where X denotes training data, Y denotes a training label, Λ denotes a parameter vector of a model, f denotes a feature vector of the model, S̅ denotes a hidden-state sequence, and m denotes the number of Gaussian distributions
